(19) United States
(12) Patent Application Publication
(10) Pub. No.: US 2003/0144913 A1
(43) Pub. Date: Jul. 31, 2003

(54) E-mail launched web transaction

(76) Inventor: Jeffrey Douglas Greenberg, Delaplane, VA (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 10/059,348

(22) Filed: Jan. 31, 2002

(51) Int. Cl. G06F 17/60

(52) U.S. Cl. 705/26

(57) ABSTRACT

In a method and apparatus for conducting electronic commerce, an email is sent to a prospective customer. The email includes an offer for sale, a field in which customer information may be entered by the customer, and a button which may be activated by the customer to accept the offer. Upon activation of the button, a secure communications channel is established between the customer's computer and a transaction server. The secure channel is preferably established by spawning a browser window and using support for secure channels built into the browser. The acceptance of the offer is sent via the secure channel and a confirmation of the offer is then sent to the customer, preferably to the browser window. The order may be forwarded to a merchant for processing.

### BACKGROUND OF THE INVENTION

1. Field of the Invention

The invention relates to electronic transactions generally, and more particularly to a method and apparatus for initiating a transaction from an electronic mail message.

2. Discussion of the Background

Electronic commerce has become big business. It is well known among Internet merchants that the amount of time, clicks and web pages required for a consumer to complete an Internet purchase has a direct and dramatic effect on sales. Therefore, much effort has been expended in minimizing the amount of time and number of actions required to make an Internet purchase. An example of a U.S. patent directed toward this problem is U.S. Pat. No. No. 5,960,411 (“the '411 patent”), which is directed to a method and system that allows an Internet purchase to be made with a single click of a user's mouse. While the '411 patent does streamline the purchasing process somewhat, it still suffers from the drawback that a user must first locate the desired item in order to place an order for it and thus does not streamline the purchase process to the fullest extent possible. It is also known to send emails to customers that include links to merchant websites. While such emails provide a shortcut to a merchant's website, the user must still click on the link to go to the merchant's website and then perform further actions in order to initiate the transaction.

What is needed is a streamlined process that will further minimize the amount of time and effort required to initiate and complete an electronic commerce transaction.

### SUMMARY OF THE INVENTION

The present invention meets the aforementioned need to a great extent by providing a system and method in which an electronic mail message (an “email”) which includes a description of a proposed transaction (e.g., a description of goods for sale along with a price for the goods) is sent to an end user and the end user is provided with the ability to initiate and complete the transaction by activating a button in the email without the need for the end user to visit the website. The transaction is preferably conducted using a secure channel technology such as Secure Socket Layer (SSL) or Transport Layer Security (TLS). In one embodiment, the secure channel is established by spawning a browser window and utilizing support for secure channels that is built into the browser.

In one embodiment of the invention, the user completes an order form in the email including data such as name, address, credit card number, etc., prior to initiating the transaction. The entered data is automatically transferred to a transaction server upon initiation of the transaction.

In another embodiment of the transaction, a customer number, or other identifying data (e.g., name and address) is included in the email received by the end user and automatically sent to the transaction server, thereby further simplifying the purchasing process. The identifying data may be linked to a credit card that is known to the merchant in advance such that transmitting the credit card number for each purchase is not necessary. Alternatively, all customer identification other than the credit card number may be included in the email and the customer is only required to enter the credit card number prior to initiating the transaction.

### BRIEF DESCRIPTION OF THE DRAWINGS

A more complete appreciation of the invention and many of the attendant features and advantages thereof will be readily obtained as the same become better understood by reference to the following detailed description when considered in connection with the accompanying drawings, wherein:

FIG. 1 is a sequence diagram showing the transfer of an email according to one embodiment of the present invention.

FIG. 2 is a screen shot showing the email of FIG. 1.

FIG. 3 is a sequence diagram showing the initiation of a transaction from the email of FIG. 2.

FIG. 4 is a screen shot of a website showing a confirmation of the transaction initiated from the email of FIG. 2.

### DETAILED DESCRIPTION OF THE PREFERRED EMBODIMENTS

The present invention will be discussed with reference to preferred embodiments of methods and system for initiating electronic commerce transactions from email. For ease of understanding, certain method steps are delineated as separate steps; however, these steps should not be construed as necessarily distinct nor order dependent in their performance. Specific details, such as types of transactions, types of data required for transactions, etc., are provided in order to provide a thorough understanding of the invention. The preferred embodiments discussed herein should not be understood to limit the invention.

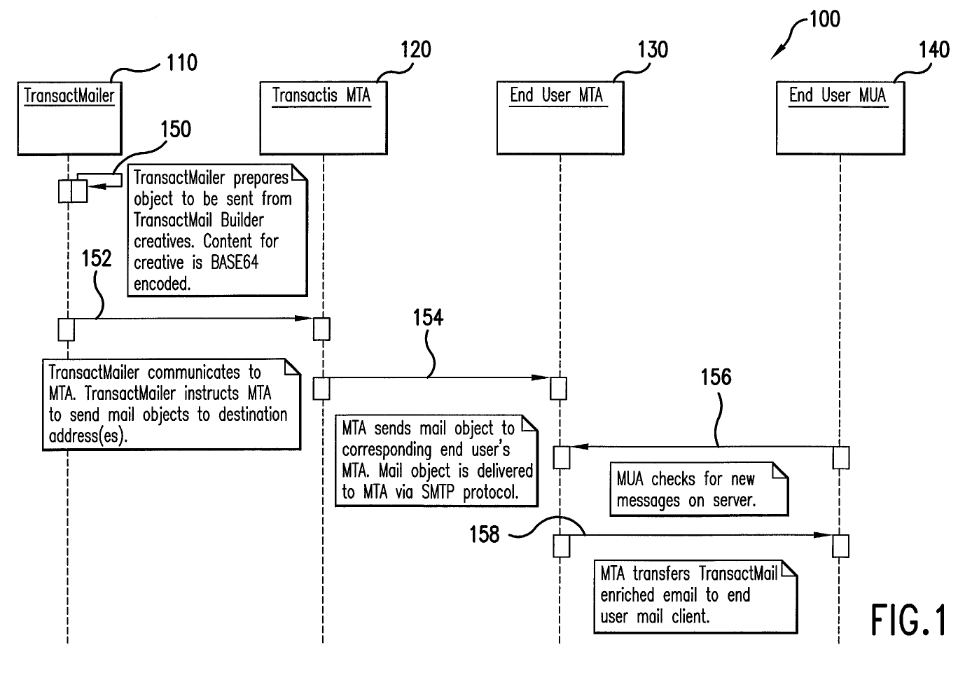

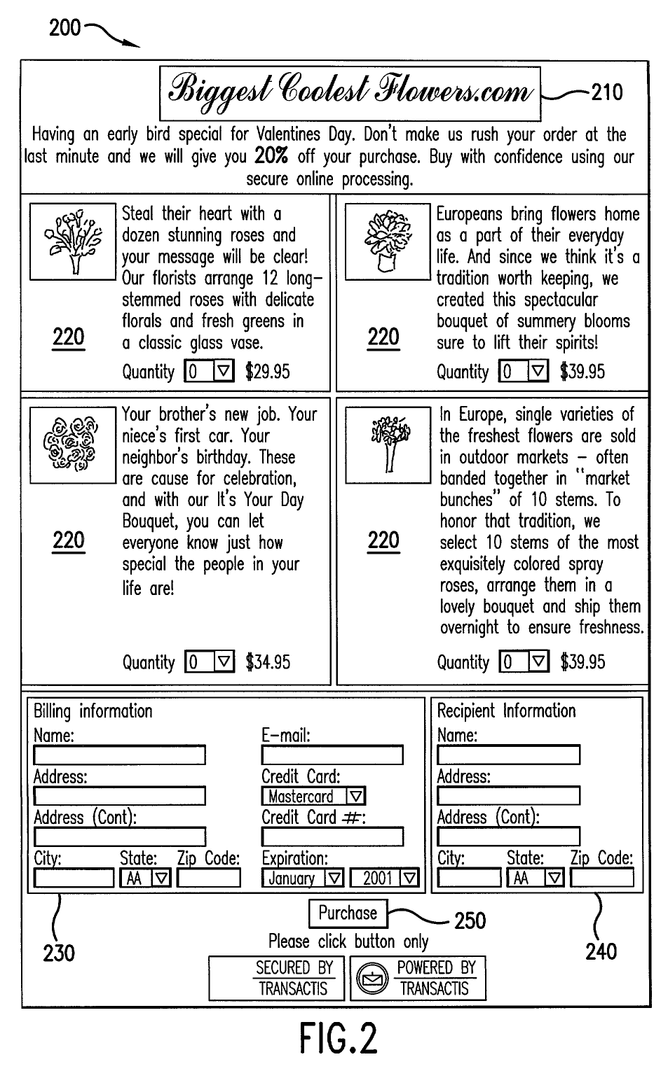

Referring now to the drawings, wherein like reference numerals designate identical or corresponding parts, a sequence 100 of steps 150-158 for creating and transferring an email according to an embodiment of the invention is illustrated in FIG. 1. At step 150, an email object is composed at a processor 110. An exemplary form of email object, or simply email, 200, in which flowers are offered for sale, is illustrated in FIG. 2.

The email 200 includes a field 210 in which is displayed the name of the merchant selling the flowers. Fields 220 show various flower arrangements being offered for sale. In email 200, four different flower arrangements are offered. In preferred embodiments of the invention, the number of different goods/services is kept small, preferably 1-5 goods/services, although larger numbers of goods/services are within the purview of the invention. The email 200 also includes a billing information field 230 into which a customer receiving the email may enter billing information such as name, address, and credit card information. The email 200 further includes a recipient information field 240, which may be used to enter shipping information in the event that it is different from the billing information. Finally, the email 200 includes a Purchase “button” 250, which the customer may press to initiate the transaction offered in the email. (As used herein, the term button is used in a generic sense and should be understood to refer to any mechanism, now known or later developed, by which a customer can indicate a desire to accept a proposed transaction.) The email 200 is preferably composed using HTML (Hyper Text Mark-up Language) in a manner that is well known in the art. Base64 encoding may be used to hide underlying email text and code from the user.

Referring now back to FIG. 1, after the email 200 has been composed, the processor 110 transmits the email 200 to a mail transfer agent (i.e., an email server) 120 along with a destination(s) for the email 200 at step 152. The mail transfer agent 120 then sends the email 200 to the required destinations including a customer mail transfer agent 130 at step 154, preferably using Simple Mail Transfer Protocol (SMTP). The email 200 is stored at the end user mail transfer agent 130 until the customer's mail user agent 140 (e.g., Microsoft Outlook Express) checks for new messages at step 156. Then, the email 200 is sent from the end user mail transfer agent 130 to the end user mail user agent 140, where it is viewed by the customer using the mail user agent 140.

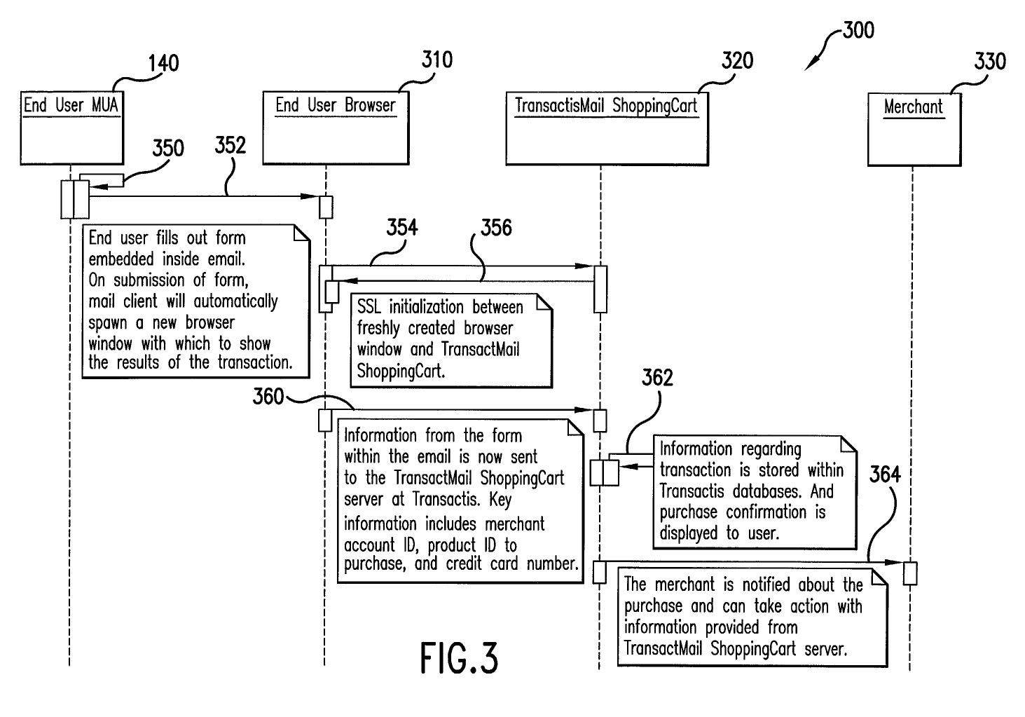

Referring now to FIG. 3, if the customer viewing the email 200 decides to purchase any of the goods or services shown in the email 200, the customer enters the required information (e.g., name, address and credit card number) in the billing information field 230 and any other required/desired information (e.g., quantity of items ordered, shipping information, etc.) at step 350. When the customer activates the Purchase button 250, the mail user agent 140 spawns a new browser window 310 (which preferably can be seen by the customer) with a request that includes an https URL (uniform resource locator) for a transaction server 320 and the information entered by the customer as step 352. This causes the browser window 310 to initiate SSL handshaking and certificate exchange with the transaction server 320 at steps 354 and 356, thereby causing a secure communications channel to be established. Once the secure channel between the transaction server 320 and the browser window 310 has been established, the customer information is sent from the new browser window 310 to the transaction server 320 at step 360.

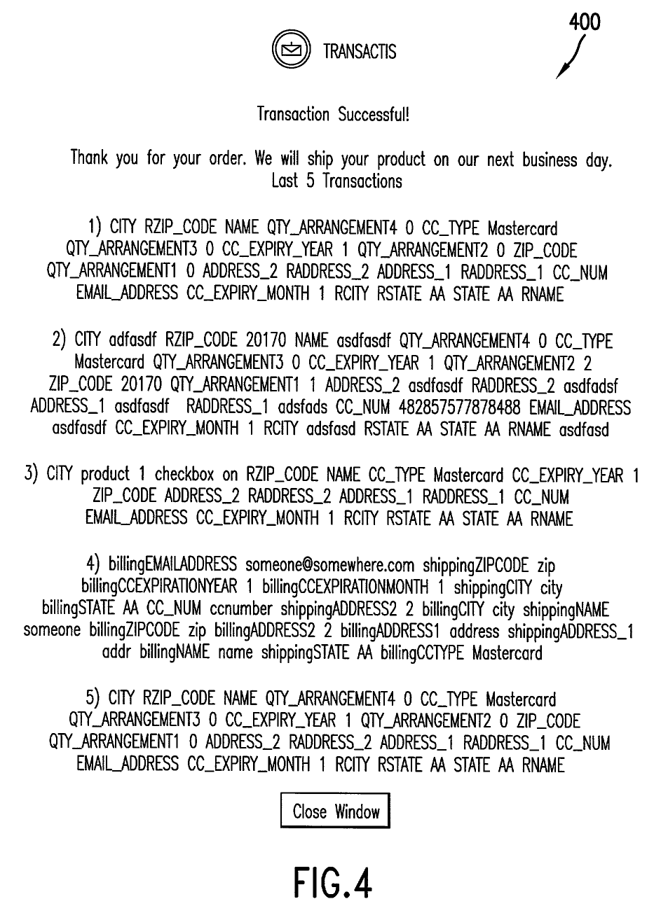

The transaction server 320 then stores the transaction in a database and downloads a confirmation 400 (as shown in FIG. 4) of the transaction to the new browser window 310 at step 362. Finally, at step 364, the merchant server 330 is notified of the transaction and takes the appropriate action based on the information provided by the customer.

It should be noted that, with the exception of the customer filling in the information discussed in connection with step 350, which is done “in the email” (that is, the customer enters the information in the same window in which the email is displayed by the mail user agent 140), the entire transaction is completed with a single click of the Purchase button 250 from the point of view of the customer. There is no need for the customer to go to a website, or even open a browser window, prior to viewing the email 200 and activating the Purchase button 250. This makes it much easier for a customer to order a desired product as compared to known methods.

In the embodiment illustrated in FIGS. 1-4, the customer is required to enter identification information such as name and address. In some embodiments, in which individualized emails are directed toward targeted customers, the information in these fields may be inserted into the email in advance. In still other embodiments, emails to existing customers may include a customer identification code which is transmitted to the transaction server 320 when a “Purchase Using Default Options” button is activated. In these embodiments, the customer code sent to the merchant is all that is needed as the merchant may have pre-stored all of the information needed to complete the transaction. In these embodiments, if the default information is correct, the entire transaction may be completed with one simple click. Of course, emails in such an embodiment may also provide the customer with the opportunity to modify the default information.

As discussed above, the new browser window 310 is visible to the customer when it is opened. One of the reasons the new browser window 310 is opened is to take advantage of the built-in support for SSL/TLS secure channels provided by most current browsers such as Microsoft Internet Explorer and Netscape Navigator. This is done because most current mail user agents (e.g., Microsoft Outlook, Eudora, etc.) do not support such secure channels although they support the display of HTML documents. One possible alternative to the embodiment discussed above it to “hide” the new browser window 310 from the end user. In such an embodiment, confirmation of the transaction could be provided by way of a separate email from the transaction server 320 or the merchant server 330 to the mail user agent 140 rather than through the download of a confirmation web page to the new browser window 310. Of course, the need for a new browser window 310 may be eliminated entirely if the mail user agent 120 is equipped to support secure channel communications.

In the embodiment discussed above, the transaction server 320 and the merchant server 330 are illustrated as separate entities. Such an arrangement allows for a service provider to act as a “middle man” between the customer and the merchant selling the goods, thereby eliminating the need for any modification to the merchant's web site to be performed. This provides the opportunity for a fee to be collected by the service provider for all transactions forwarded to the merchant server 330. Such a fee might be collected as a result of the service provider having prepared and/or sent the email 200. In other embodiments, the browser window 310 communicates directly with the merchant server 330, thereby “cutting out the middle man.”

In alternate embodiments, the functions of other entities shown as separate may be performed by the same physical device. For example, the functions performed by the mail transfer agent 120 and the transaction server 320 may be performed by a single server. Those of skill in the art will recognize that other combinations of functions are similarly possible.

Obviously, numerous modifications and variations of the present invention are possible in light of the above teachings. It is therefore to be understood that within the scope of the appended claims, the invention may be practiced otherwise than as specifically described herein.

What is claimed is:

1. A method for initiating an electronic transaction comprising the steps of:
receiving, at a customer' computer, a first email to a customer, the first email including a description of an offer and a button for indicating acceptance of the offer;
spawning, at the customer's computer, a browser window;
transmitting an indication of acceptance of the offer to a transaction server upon activation of the button by the customer; and
receiving, at the customer's computer, a confirmation of receipt of the indication.

2. The method of claim 1, wherein the confirmation is received at the browser window.

3. The method of claim 1, wherein the confirmation is received in a second email.

4. The method of claim 1, further comprising the step of establishing a secure communications channel between the browser window and the transaction server.

5. The method of claim 4, wherein the first email includes a plurality of fields for entering customer information.

6. The method of claim 5, further comprising the step of transmitting the customer information to the transaction server.

7. The method of claim 6, wherein the customer information is transmitted to the transaction server from the browser window.

8. The method of claim 7, wherein the customer information is transmitted via the secure communications channel.

9. The method of claim 8, wherein the customer information includes a credit card number.

10. The method of claim 8, wherein the customer identification information includes a customer code.

11. The method of claim 5, wherein at least one of the plurality of fields is filled in prior to receipt of the email at the customer's computer.

12. The method of claim 4, wherein the secure communications channel is a secure sockets layer channel.

13. The method of claim 4, wherein the secure communications channel is a transport layer security channel.

14. The method of claim 1, wherein the browser window is displayed to the customer.

15. The method of claim 1, wherein the browser window is hidden from the customer.

16. The method of claim 1, further comprising the step of transmitting the indication of acceptance of the offer from the transaction server to a merchant server.

17. The method of claim 1, wherein the transaction server is a merchant server.

18. A method for conducting electronic commerce comprising the steps of:
sending an email to a recipient, the email including an offer for sale, a button by which the recipient can indicate a desire to accept the offer, and a field in which the recipient can enter customer information, the email being configured to spawn a browser window and cause the browser window to establish a secure communications channel between the browser window and a transaction server; and
receiving the customer information at the transaction server via the secure communications channel.

19. The method of claim 18, further comprising the step of transmitting a confirmation to the email recipient.

20. The method of claim 19, wherein the confirmation is transmitted to the browser window.

21. The method of claim 19, wherein the confirmation is transmitted to the recipient via an electronic mail service.

22. The method of claim 18, further comprising the step of transmitting the customer information from the transaction server to a merchant server.

23. The method of claim 18, wherein the customer information includes a credit card number.

24. The method of claim 18, wherein the customer information includes a code associated with the customer.

25. The method of claim 18, wherein the email includes a plurality of fields and at least one field is filled in with customer information prior to receipt of the email by the recipient.

26. A method for conducting electronic commerce comprising the steps of:
sending an email to a customer, the email including an offer for sale, a field for entering customer information, and a button which the customer may activate to accept the offer;
activating the button;
spawning a browser window;
establishing a secure channel between the browser window and a transaction server;
transmitting an indication of the customer's acceptance of the offer via the secure channel;
transmitting a confirmation of the customer's acceptance to the browser window; and
transmitting a message from the transaction server to a merchant server indicating that the customer wishes to accept the offer in the email.

27. A method for conducting electronic commerce comprising the steps of:
sending an email to a customer, the email including an offer for sale, a field for entering customer information; and a button which the customer may activate to indicate acceptance of the offer;
receiving at a transaction server a message from the customer over a secure channel, the message indicating acceptance of the offer and including customer information entered by the customer in the field;
transmitting a confirmation message to the customer; and
forwarding the message to a merchant.
